(19) United States
(12) Patent Application Publication
(10) Pub. No.: US 2010/0051684 A1
(43) Pub. Date: Mar. 4, 2010

(54) FRAUD GEOSPEED ALERTING METHOD AND SYSTEM

(76) Inventor: William Lewis-Jennings Powers, Raleigh, NC (US)

Correspondence Address: FOLEY & LARDNER LLP, 150 EAST GILMAN STREET, P.O. BOX 1497, MADISON, WI, 53701-1497, US

(21) Appl. No.: 12/202,826

(22) Filed: Sep. 2, 2008

(51) Int. Cl. G06Q 40/00

(52) U.S. Cl. 235/379

(57) ABSTRACT

An exemplary method for determining a potentially fraudulent transaction includes receiving present card location information indicating a present location and a present time for a financial transaction card and a first transaction, obtaining past card location information indicating a past location and a past time for the financial transaction card and a second transaction, calculating a distance between the present location and the past location, calculating a time duration based on the present time and the past time, determining feasibility of use of the financial transaction card at the present location and the past location based on the distance and the time duration, and generating a transaction risk alert if the feasibility determination is lower than a predetermined threshold.

### FIELD

The subject of the disclosure relates generally to a method and system for reducing financial transaction card fraud. More specifically, the disclosure relates to a fraud alerting method and system which uses location, distance, and time to determine whether use of a financial transaction card is physically impossible and, therefore, potentially fraudulent.

### BACKGROUND

Financial transaction card fraud is an increasing problem. Criminals continue to improve their methods of fraud in order to keep pace with technology advancements. They use various methods to obtain card numbers or other valuable data from valid financial transaction cards. The stolen data is then used during point of sale (POS) or internet based financial transactions. POS can mean a retail shop, a checkout counter in a shop, or the location where a transaction occurs.

There are currently many methods that are used for financial transaction fraud detection. One method utilizes a computer software that “learns” a customer's spending behavior and flags transactions that appear unusual. Another method looks at the spending habits of groups of people in a geographic area to determine transactions that seem fraudulent. Other methods utilize numerous factors that are used to generate a score, where the score provides a likelihood of fraudulent activity.

In addition to methods used to detect fraudulent transactions, there are also many devices that help to prevent financial transaction card fraud. Some of these devices include transaction cards with a built-in identification computer chip or a picture of the cardholder. There are also devices that add additional checks like verifying a person's identity from a fingerprint, password, retinal scan or cell phone location compared to the transaction location.

Consumers that use financial transactions cards at a POS have additional protection because of the physical presence of the card. The transaction string contains specific code information for any card present transaction, including a signature transaction or PIN transaction, that differs from either card not present transaction or manually keyed transactions.

### SUMMARY

Representative embodiments provide a method, computer-readable medium, and system that determine whether two transactions are physically possible when compared to each other. By using origination location and time information from the two transactions, it can be determined whether the financial transaction card could have possibly been used at the two locations. For example, it would be physically impossible for a credit card to be used to purchase fuel via a pay-at-pump device in Georgia, then five minutes later the same credit card purchase fuel via a pay-at-pump device in California.

Financial transactions can be checked for fraud individually while a transaction is being completed, or in batches at a time when a transaction is not occurring, when running operationally the solution individual, near-real time transaction processing. The solution does not include batch processing, where the transaction time does not reflect the actual time of the transaction. A representative method for determining a potentially fraudulent transaction involves receiving information for a first financial transaction. The information from the first financial transaction includes a first location and a first time. The first financial transaction could be a present transaction where a customer is currently seeking card authorization or a past transaction that is being processed as part of a batch of transactions if the transaction time reflects the actual time of the transaction. The representative method further involves obtaining a second financial transaction with information that includes a second location and a second time. A distance is then calculated using the first location and the second location. Also, a time duration is calculated based on the first time and the second time. Using the distance and the time duration, it is determined how feasible it would be to use the financial transaction card at the first location and the second location. Optionally, a transaction risk alert can be generated if the feasibility determination is lower than a predetermined threshold.

A representative computer-readable medium has computer-readable instructions stored thereon that, upon execution by a processor, cause the processor to calculate a distance between a first location from a first transaction completed with a financial transaction card and a second location from a second transaction completed with the financial transaction card. The computer-readable instructions calculate a time duration based on a first time for the first transaction and a second time for the second transaction. The computer-readable instructions also determine the feasibility of use of the financial transaction card at the first location and the second location based on the calculated distance and time duration. Optionally, the computer-readable instructions can generate a transaction risk alert if the feasibility determination is lower than a threshold.

A representative system for reducing fraudulent transactions involving a financial transaction card includes the means for calculating a distance between a first location from a first transaction completed with the financial transaction card and a second location from a second transaction completed with the financial transaction card. The system also includes means for calculating a time duration based on a first time for the first transaction and a second time for the second transaction. The system further includes means for determining feasibility of use of the financial transaction card at the first location and the second location based on the calculated distance and time duration. Optionally, the system includes the means for generating a transaction risk alert if the feasibility determination is lower than a threshold.

Other principal features and advantages will become apparent to those skilled in the art upon review of the following drawings, the detailed description, and the appended claims.

### BRIEF DESCRIPTION OF THE DRAWINGS

Representative embodiments will hereafter be described with reference to the accompanying drawings.

FIG. 1 is a flow diagram illustrating a high level view of operations performed by a fraud geospeed alert system in accordance with a representative embodiment.

FIG. 2 is a flow diagram illustrating more specific operations performed by the fraud geospeed alert system in accordance with a representative embodiment.

FIG. 3 is a block diagram illustrating a fraud geospeed alert backend database system in accordance with a representative embodiment.

### DETAILED DESCRIPTION

Described herein are a method, computer-readable medium, and system for reducing fraudulent financial card transactions. The system includes the capturing of location information during the processing of credit or debit card transactions. Location information for a first transaction is compared to the location information for a second transaction to determine the feasibility of the card actually being used in both locations. If it is determined that the locations of the transactions violate pre-determined geospeed rules, an alert is created. The alarm can be a signal communicated to deny the present transaction. The alarm can also be a flag marking the present transaction to require follow-up with the owner of the financial transaction card.

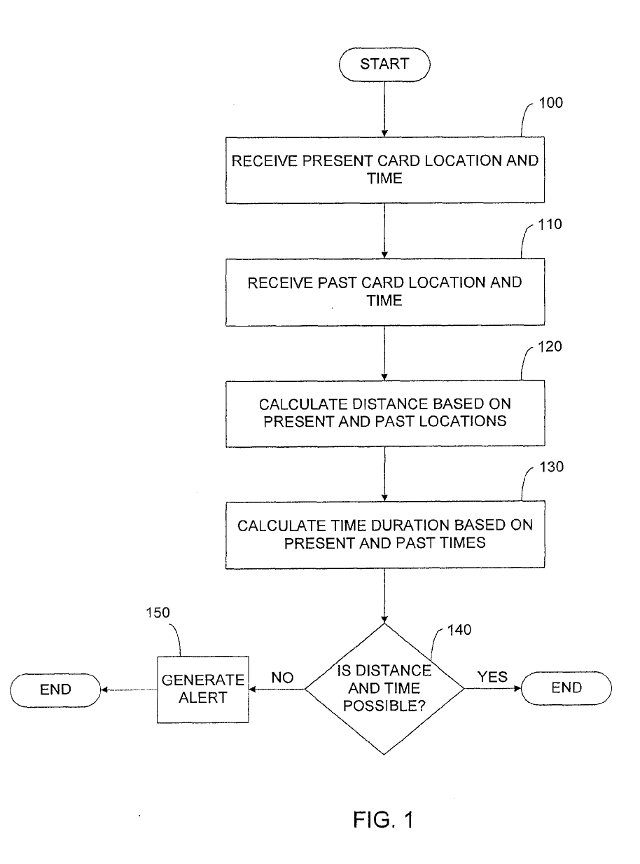

FIG. 1 is a flow diagram illustrating a high level view of operations performed by a fraud geospeed alert system in accordance with a representative embodiment. In alternative embodiments, fewer, additional, or different operations may be performed. In an operation 100, a present card location and a present card time is received indicating the location or approximate location of a present financial transaction, such as a credit or debit card POS transaction. A representative embodiment receives the present card location and time information via merchant information transmitted along with card processing data in a payment processing system.

In an operation 110, a past card location and a past card time is received indicating the location or approximate location of a past financial transaction, such as a credit or debit card POS transaction. A representative embodiment receives the past card location and time information via merchant information transmitted along with card processing data in a payment processing system.

In an operation 120, a distance is calculated based on the present card location and the past card location. The distance is calculated by a computing device which takes approximate location information, such as longitude and latitude coordinates, and computes an approximate distance between the two locations. In some embodiments, approximate distances can be utilized. In other embodiments, actual distances are used.

In an operation 130, a time duration is calculated based on the present card transaction time and the past card transaction time. The time duration is the difference between the present card transaction time and the past card transaction time. In some embodiments, the time duration is measured in hours, minutes, and seconds.

In an operation 140, a determination is made whether it is physically possible for the financial transaction to occur in the present location considering the time duration and distance from the use of the financial transaction card at the past location. If the determination is made that such use is possible, the fraud detection for the present transaction is ended. If the determination is made that such use is not possible, an alarm may be generated in operation 150. The alarm can be a signal communicated to deny the present transaction. The alarm can also be a flag marking the present transaction to require follow-up with the owner of the financial transaction card.

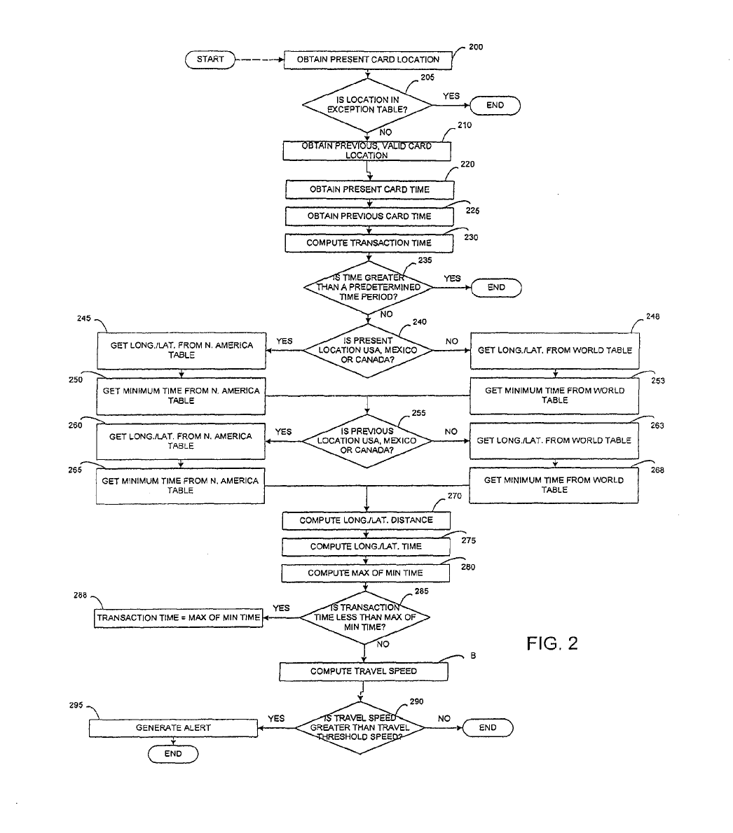

FIG. 2 is a flow diagram illustrating more specific operations performed by the fraud geospeed alert system in response to a request for payment in accordance with a representative embodiment. In alternative embodiments, fewer, additional, or different operations may be performed. In an operation 200, a present card location from a present financial transaction is received indicating the location or approximate location of the present financial transaction, such as a credit or debit card POS transaction. A representative embodiment receives the present card location information via merchant information transmitted along with card processing data in a payment processing system.

In an operation 205, a terminal ID exception table is checked to see if the present financial transaction occurred at a terminal with accurate location information. If the terminal ID exception table indicates an inaccurate location, the fraud detection for the present financial transaction is ended. This check is done early in the process in order to save processing time.

If the terminal ID exception table indicates an accurate location, the fraud detection for the present financial transaction continues. In an operation 210, a previous card location from a previous financial transaction is received indicating the location or approximate location of the previous financial transaction, such as a credit or debit card POS transaction. A representative embodiment receives the previous card location information via merchant information transmitted along with card processing data in a payment processing system.

In an operation 220, a present card time from the present financial transaction is received indicating the time or approximate time of the present financial transaction. In an operation 225, a previous card time from the previous financial transaction is received indicating the time or approximate time of the previous financial transaction.

In an operation 230, the present card time from operation 220 and the previous card time from operation 225 are used to compute a transaction time. A representative embodiment computes the time difference between the present card time and the previous card time in order to determine the transaction time. For example, if the previous card time occurred today at 01:00 (hour:minute) and the present card time occurred today at 01:35, the transaction time would be 35 minutes.

In an operation 235, the computed transaction time is checked to see if it is greater than a predetermined time period. If the computed transaction time is greater than the predetermined time period, the fraud detection for the present transaction is ended. A representative embodiment of the predetermined time period may be 22 hours. This check is done early in the process in order to save processing time.

If the computed transaction time is less than the predetermined time period, the fraud detection for the present transaction continues. In an operation 240, the present card location is checked to determine if it is within the United States, Mexico, or Canada. If the present card location is within the United States, Mexico, or Canada, in an operation 245, a present transaction latitude and a present transaction longitude are obtained from a North America Table. In an operation 250, a minimum present time is also obtained from the North America Table.

If the present card location is not within the United States, Mexico, or Canada, in an operation 248, a present transaction latitude and a present transaction longitude are obtained from a World Table. In an operation 253, a minimum present time is also obtained from the World Table.

In an operation 255, the previous card location is checked to determine if it is within the United States, Mexico, or Canada. If the previous card location is within the United States, Mexico, or Canada, in an operation 260, a previous transaction latitude and a previous transaction longitude are obtained from a North America Table. In an operation 265, a minimum previous time is also obtained from the North America Table.

If the previous card location is not within the United States, Mexico, or Canada, in an operation 263, a previous transaction latitude and a previous transaction longitude are obtained from a World Table. In an operation 268, a minimum previous time is also obtained from the World Table.

In an operation 270, the present transaction latitude (lat₁) from operation 245 or 248, the present transaction longitude (lon₁) from operation 245 or 248, the previous transaction latitude (lat₂) from operation 260 or 263, and the previous transaction longitude (lon₂) from operation 260 or 263 are used to compute a distance (DIST). A representative embodiment of a distance calculation, where DIST is a distance in miles, is:

$$DIST = \sqrt{{x}^{2} + {y}^{2}}$$

$$where x = 69.1 * ( {lat}_{2} - {lat}_{1} )$$

$$and y = 69. * ( {lon}_{2} - {lon}_{1} ) * cos ( \frac{{lat}_{1}}{57.3} ) .$$

In an operation 275, a scaled time (tₛ) is calculated. The scaled time is calculated by using the data between the two locations and converting the time into minutes.

In an operation 280, a maximum of minimum time is calculated. The maximum of minimum time is the greater of the minimum present time from operation 250 or 253 and the minimum previous time from operation 265 or 268. For example, if the minimum present time was 45 minutes and the minimum previous time was 75 minutes, the maximum of minimum time would be 75 minutes.

In an operation 285, the transaction time from operation 230 is checked to determine if it is less than the maximum of minimum time from operation 280. If the transaction time is less than the maximum of minimum time, in an operation 288 the transaction time equals the maximum of minimum time. For example, if the transaction time was 70 minutes and the maximum of minimum time was 75 minutes, than the transaction time would be less than the maximum of minimum time, so the transaction time would then equal 75 minutes.

In an operation 290, the transaction time from operation 230 or 288 is used in conjunction with the distance from operation 270 to calculate the speed (in miles-per-hour) that one would have to travel in order to move the distance from the location of the present transaction to the location of the previous transaction. If the speed exceeds a previously determined threshold, an alert is generated. The speed is a set variable, but generally acknowledged to be around 450 miles-per-hour. The speed needs to be about the same speed as an aircraft in order to avoid any potential financial transactions that occur by a financial card being used prior to boarding an aircraft then directly after exiting an aircraft.

The fraud geospeed alert system code logic could resemble the following:

```
Get PresentCPTransLocation
    If PresentCPTransLocation is in the exception table, Exit
Get PreviousCPTransLocation
    If no qualifying Previous CPTransLocation is found, Exit
Get PresentCPTransTime
Get PreviousCPTransTime
Compute TransactionTime
    If TransactionTime > 22:00 Exit
If PresentCPTransLocation = USA, Mexico, or Canada
    Get LongLat from NorthAmerica Table
    Get MinimumTime from NorthAmerica Table
Else
    Get LongLat from World Table
    Get MinimumTime from World Table
If PreviousCPTransLocation = USA, Mexico, or Canada
    Get LongLat from NorthAmerica Table
    Get MinimumTime from NorthAmerica Table
Else
    Get LongLat from World Table
    Get MinimumTime from World Table
Compute LongLatDistance
Compute MaximumOfMinimumTimes
If TransactionTime < MaxMinTime Then TransactionTime =
MaxMinTime
Compute TravelSpeed
If TravelSpeed > ThresholdTravelSpeed Generate Alert
```

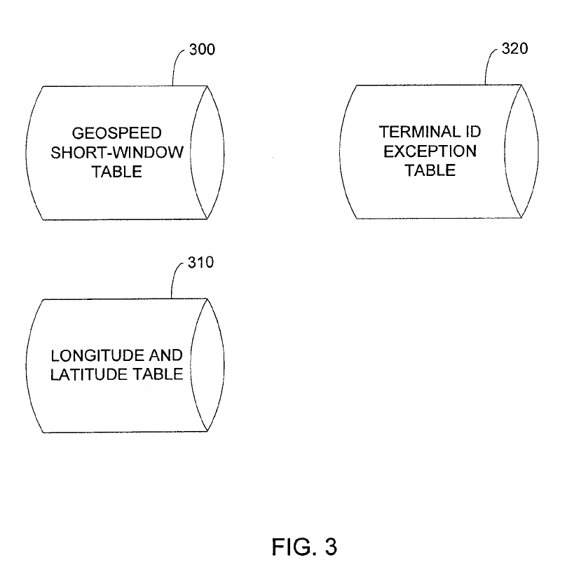

FIG. 3 is a block diagram illustrating a fraud geospeed backend database system in accordance with a representative embodiment. A first data source 300, a second data source 310, a third data source 320, and a fourth data source 330 can provide data elements and/or fraud data to the payee fraud reduction system (system).

Information in the data sources can include information stored in data tables, such as a geospeed short-window table 300, a longitude and latitude table 310, a terminal ID exception table 320.

A representative embodiment of the geospeed short-window table 300 includes transactions for review. Columns in the geospeed short window table could include: Card Number, Location Country, Location State, Terminal ID, Time of Transaction, and a column reserved for future BTID use (20 characters) A BTID is an optional, processor dependent value assigned to each transaction, for use if multiple transaction overlap with identical information.

A representative embodiment of the longitude and latitude table 310 contains the longitude and latitude for each country and sub-states within countries. In one embodiment, only North America is broken down by sub-state. A single table with all countries, or two tables with North America in one table and the rest of the world in another table may be used.

If two tables are used, the North America Table can include individual states, or provinces as its largest locations. This allows intra-continent checks and worldwide longitude/latitude comparisons to be fairly accurate. The World Table is organized by individual country because when there is an ocean between transactions, there is not a great need to divide the table into smaller areas. The World Table works well for small countries that are near the US because they are not large enough to offset the speed map significantly (ie. Bermuda and Carribean islands). Since the North America Table can be defined for areas within a small range, other areas appearing as US locations can be included in the longitude and latitude table instead of on the terminal ID exception table. For example, Guam can be a location in the longitude and latitude table instead of in the terminal ID exception table.

The longitude and latitude table should also contain a minimum time for the location. The minimum time is used as an aid to determine the amount of time required for a geospeed alert.

The minimum time helps to resolve any time problems caused by cross-border (USA, MX) or cross-state (WI,MN) transactions. Generally, the minimum time is should be set to 45 minutes; however, for larger states, countries, or cross-border situations, the minimum time should be set to a larger value. In cases where the minimum times are different, the largest minimum time should be used as shown in 280. For example, if the minimum time of North Dakota is 45 minutes, and the minimum time for Canada is 75 minutes, the minimum time of 75 minutes should be used. Using the larger minimum time should alleviate issues with service companies that work on-site but charge financial transactions to a central location.

A representative embodiment of the terminal ID exception table 320 should include a list of terminal IDs that track to inaccurate locations, such as military bases in foreign countries where a POS device reports that a financial transaction is occurring in a location within the United States. Each database row could contain two entries for comparison, the Terminal ID, and the Acquirer ID. The Terminal ID is a specific number assigned to each terminal per acquirer in the world, similar to an IP address. The Acquirer ID shows the terminal data acquirer. In addition to the comparison entries, the terminal ID exception table can contain tracking information, including a date entry field for use with short term terminal ID exceptions (such as a misplaced terminal), and where the exception entry is automatically removed when the date entered is reached. A second date entry field automatically updates to the date the row was updated. The final entry per row shows the user ID of the person who entered the data. The second date entry and the person updating could be populated automatically. All of the later, optional fields are for auditing purposes, and could be managed through a separate auditing system.

One or more flow diagrams have been used to describe exemplary embodiments. The use of flow diagrams is not meant to be limiting with respect to the order of operations performed. The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method for determining a potentially fraudulent transaction involving a transaction card, the method comprising:
receiving, at a computing device, first transaction information including a first location and a first time of a first transaction for a transaction card;
receiving, at the computing device, second transaction information including a second location and a second time of a second transaction for the transaction card;
calculating a distance between the first location and the second location using the computing device;
calculating a time duration between the first time and the second time using the computing device; and
determining, via the computing device, feasibility of use of the transaction card at the first location and the second location based on the distance and the time duration.

2. The method of claim 1, further comprising generating a transaction risk alert if the use of the transaction card at the first location and the second location is determined to not be feasible.

3. The method of claim 1, wherein said receiving first transaction information comprises receiving a first terminal identifier, and wherein said receiving second transaction information comprises receiving a second terminal identifier.

4. The method of claim 3, further comprising obtaining country and state information from a first table of values based on at least one of the first location and the second location.

5. The method of claim 4, further comprising obtaining a longitude and a latitude value from a second table of values based on the country and state information.

6. The method of claim 1, further comprising comparing at least one of the first or second transaction locations to a terminal identification exception table to verify if at least one of the first or second transactions occurred at a terminal with accurate location information.

7. A computer-readable medium having computer-readable instructions stored thereon that, upon execution by a processor, cause the processor to:
calculate a distance between a first location of a first transaction for a transaction card and a second location of a second transaction for the transaction card;
calculate a time duration based on a first time for the first transaction and a second time for the second transaction; and
determine feasibility of use of the transaction card at the first location and the second location based on the distance and the time duration.

8. The computer-readable medium of claim 7, wherein the computer-readable instructions, upon execution by the processor, further cause the processor to generate a transaction risk alert if the use of the transaction card at the first location and the second location is determined to not be feasible.

9. The computer-readable medium of claim 7, wherein the computer-readable instructions, upon execution by the processor, further cause the processor to calculate a speed necessary to travel from the first location to the second location.

10. The computer-readable medium of claim 9, wherein the computer-readable instructions stored thereon, upon execution by the processor, further cause the processor to:
obtain country and state information from a first table of values based on at least one of the first location and the second location; and
obtain a longitude and a latitude value from a second table of values based on the country and state information.

11. A system for reducing fraudulent transactions involving a transaction card, the system comprising:
means for calculating a distance between a first location of a first transaction for a transaction card and a second location of a second transaction for the transaction card;
means for calculating a time duration based on a first time for the first transaction and the second time for the second transaction; and
means for determining feasibility of use of the transaction card at the first location and the second location based on the distance and the time duration.

12. The system of claim 11, further comprising means for generating a transaction risk alert if the use of the transaction card at the first location and the second location is determined to not be feasible.

13. The system of claim 11, further comprising means for calculating a speed necessary to travel from the first location to the second location.

14. The system of claim 11, further comprising
means for obtaining country and state information from a first table of values based on at least one of the first location and the second location; and
means for obtaining a longitude and a latitude value from a second table of values based on the country and state information.

15. A method for determining a potentially fraudulent transaction involving a transaction card, the method comprising:
receiving, at a computing device, first transaction information including a first location and a first time of a first transaction for a transaction card;
receiving, at the computing device, second transaction information including a second location and a second times of a second transaction for the transaction card;
calculating a speed necessary to travel from the first location to the second location using the computing device; and
determining, via the computing device, feasibility of use of the transaction card at the first location and the second location based on the speed necessary to travel from the first location to the second location.

16. The method of claim 15, wherein said determining comprises comparing the speed necessary to travel from the first location to the second location to a predetermined value.

17. The method of claim 15, wherein said calculating a speed necessary to travel from the first location to the second location comprises:
calculating a distance between the first location and the second location using the computing device; and
calculating a time duration between the first time and the second time using the computing device.

18. The method of claim 1, further comprising generating, at the computing device, a signal to deny at least one of the first or second transactions if the use of the transaction card at the first location and the second location is determined to not be feasible.

19. The method of claim 1, further comprising generating, at the computing device, a flag configured to require contacting an owner of the transaction card if the use of the transaction card is determined to not be feasible.

20. The method of claim 1, wherein the transaction card is a credit card or a debit card.

21. The method of claim 1, wherein the first and second transactions are point-of-sale (POS) transactions.

22. The method of claim 1, further comprising comparing the time duration to a predetermined value.

23. The method of claim 1, wherein the first and second transaction information is received via merchant information transmitted with card processing data in a payment processing system.

24. The computer-readable medium of claim 7, wherein the computer- readable instructions, upon execution by the processor, further cause the processor to generate a signal to deny at least one of the first or second transactions if the use of the transaction card is determined to not be feasible.

25. The computer-readable medium of claim 8, wherein the transaction risk alert comprises a flag configured to require contacting an owner of the transaction card if the use of the transaction card is determined to not be feasible.

26. The computer-readable medium of claim 7, wherein the transaction card is a credit card or a debit card, and wherein the first and second transactions are point-of-sale (POS) transactions.

27. The computer-readable medium of claim 7, wherein the computer- readable instructions, upon execution by the processor, further cause the processor to:
compare the time duration to a predetermined value; and
not determine the feasibility of the use of the transaction card if the time duration exceeds the predetermined value.

28. The computer-readable medium of claim 7, wherein the computer- readable instructions, upon execution by the processor, further cause the processor to compare at least one of the first or second transaction locations to a terminal identification exception table to determine if at least one of the first or second transactions occurred at a terminal having accurate location information.
